(19) United States
(12) Patent Application Publication
(10) Pub. No.: US 2015/0248840 A1
(43) Pub. Date: Sep. 3, 2015

(54) EQUIPMENT-BASED EDUCATIONAL METHODS AND SYSTEMS

(71) Applicant: Discovery Learning Alliance, Silver Spring, MD (US)

(72) Inventors: Marithza ALDAZABAL, Lima (PE); Jen CAMPBELL-PITT, Johannesburg (ZA); Paula DZORWULU, Accra (GH); Claire MANEJA, Makati City (PH); Ndo MBAMBO, Centurion (ZA); Tamela NOBOA, Potomac, MD (US)

(21) Appl. No.: 14/636,002

(22) Filed: Mar. 2, 2015

Related U.S. Application Data
(60) Provisional application No. 61/946,562, filed on Feb. 28, 2014.

(51) Int. Cl. G09B 5/06; G09B 19/00

(52) U.S. Cl. CPC G09B 5/065; G09B 19/00

(57) ABSTRACT

The educational methods and apparatus may include developing a learning center integrating audio-visual learning techniques and technology. The methods and apparatus may also include providing teacher training. The methods and apparatus may include receiving input from the community regarding topics of interest and providing educational input, using the technology, on a received topic of interest.

### RELATED APPLICATIONS

This application claims priority to U.S. Application No. 61/946,562 entitled “Equipment-Based Educational Methods and Systems,” filed Feb. 28, 2014, which is incorporated herein by reference in its entirety.

### BACKGROUND

Audio-visual materials may be used as a teaching and learning tool. As many students are visual learners, audio-visual materials can be used in the classrooms to take students to places the students may never visit in any other way. For example, audio-visual materials may bring other countries, cultures, plants, animals, and outer space into the classroom allowing students to see subjects clearly and colorfully. Audio-visual materials may also provide teachers with a way of helping students expand their views on the world by bringing the world into the classroom. In addition, audio-visual materials may be a resource to make learning more visual, multi-dimensional, and interactive.

### SUMMARY

Aspects of the present invention relate to methods and apparatus that, among other things, integrate audio-visual content into learning. Aspects of the present invention may include a participatory approach to creating learning centers that integrate audio-visual content into education. The participatory approach may include participatory engagement of the community from the outset, teacher training, and follow-up support with an emphasis on identifying best practices for the learning center.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

In the drawings:

FIG. 1 illustrates an example educational method in accordance with an aspect of the present invention;

FIG. 2 illustrates an example method for integrating audio-visual learning techniques and technology in accordance with an aspect of the present invention;

FIG. 3 illustrates an example audio-visual content list in accordance with an aspect of the present invention;

FIGS. 4A and 4B illustrate an example lesson plan in accordance with an aspect of the present invention;

FIGS. 5A and 5B illustrate an example assessment in accordance with an aspect of the present invention;

FIG. 6 illustrates various features of an example computer system for use in conjunction with aspects of the present invention; and

FIG. 7 illustrates an example system diagram of various hardware components and other features for use in accordance with aspects of the present invention.

### DETAILED DESCRIPTION

Aspects of the present invention relate to methods and apparatus that, among other things, integrate audio-visual content into education. For example, audio-visual materials may be used in creative and fun ways to make learning more visual, multidimensional, and interactive. Aspects of the present invention may include developing a learning center in a community to integrate audio-visual content, including analog and/or digital content, into education. Sustainable audio-visual equipment (e.g., television and a DVD player, or a laptop and a projector) may be provided to a community for use in a learning center.

Aspects of the present invention may use a participatory process to design and implement programs to best use audio-visual materials as a learning tool, link audio-visual materials to educational goals, and use audio-visual materials to address community needs and challenges. Aspects of the present invention may support local ownership in the development of the learning centers and local ownership of the learning center programs from the outset by working closely with the school and community to develop a learning center that supports the integration of audio-visual learning within school and community life. For example, community members, such as but not limited to, national Ministries, implementing agencies, and district education offices may help determine geographic target areas for the learning centers and may help to develop criteria for school selection. Thus, by involving the community in the learning centers from the outset, bridges may be built among the communities and the learning centers.

In addition, aspects of the present invention may include creating original content and/or curating content for use in the learning centers. The content may be created or selected in collaboration with educators in various countries to use in the education programs at the learning center. Content may include, but may not be limited to, video, audio, multimedia files, image files, documents, text, and music, among other content.

Aspects of the present invention may also provide teacher training to help teachers learn to integrate audio-visual content and student-centered approaches within teaching while satisfying a national curriculum. The teacher training may help the teachers learn how to set up audio-visual resources in the classrooms, introduce the teachers to the audio-visual library, and help the teachers create links between the video content in the video library and the syllabus content.

Aspects of the present invention also include promoting gender equality and works to support national level commitments to gender equality and education for women and girls. For example, teachers may receive training in the development of gender responsive schools and classrooms in the development of girls clubs. Audio-visual resources may be used, for example, to support thematic learning on leadership, careers, goal setting, and positive assertiveness.

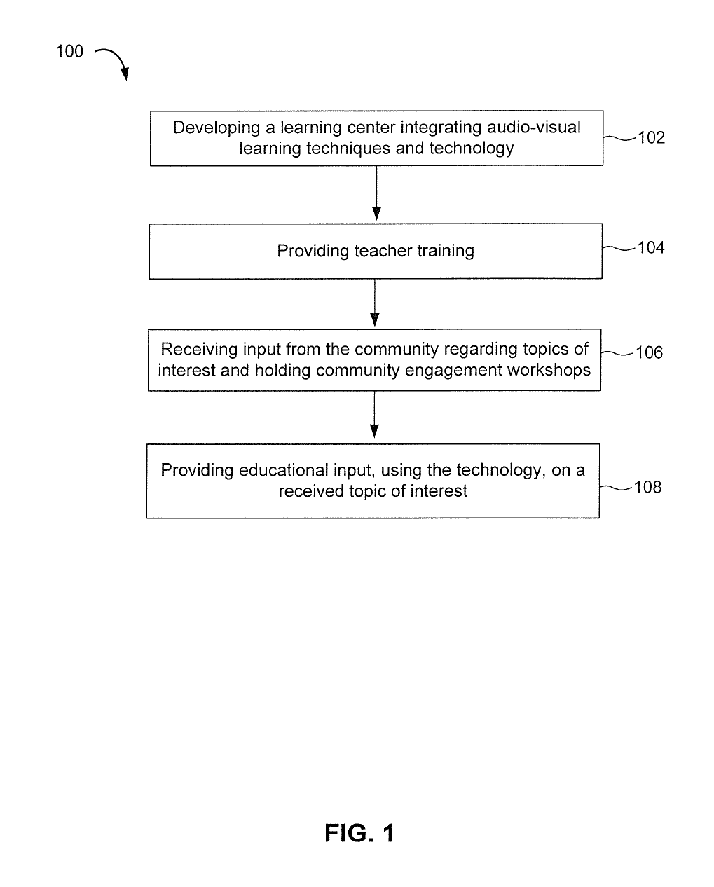

Referring now to FIG. 1, illustrated therein is an example educational method 100 in accordance with an aspect. The method may include developing a learning center integrating audio-visual learning techniques and technology 102. The learning center may provide a hub for community engagement and learning. For example, the learning center may support the integration of video learning within school and community life while fostering the development of learning skills. The learning center may house a video library and video equipment (e.g., a television and DVD player or a laptop and a projector) used for learning. The learning center may have a learning center portfolio that houses information about how the learning center is used, student work samples, letters from the community, and favorite video programs. In an aspect, the system may store the video library and the learning center portfolio for each learning center.

In an aspect, stakeholders in the community may be engaged from the outset in creating the learning center. Stakeholders in the community may include, but are not limited to, Ministry of Education officials, regional and district education offices, community opinion leaders, parents, school administrators, teachers, and students. Each stakeholder group may bring a different perspective to identifying needs for the learning center, suggesting best approaches for success of the learning center, and developing strategies that address any challenges that may arise in developing the learning center. By engaging stakeholders in the community from the outset and having local ownership in the learning center, the learning center may have a better chance of success, and student enrollment and learning may increase.

In an aspect, a learning center management committee may be established by the school and the community. The learning center management committee may include a combination of individuals, such as, teachers, school administration, and community members, among others. The learning center management committee may document learning center information for the learning center. For example, the learning center management committee may ensure that the use of the learning center is tracked, the audio-visual equipment is maintained and stored safely, and the ongoing professional development needs of the teachers are met. In addition, the learning center management committee may also create action plans for the learning center to promote positive changes in the learning center and create local partnerships with local resources to help with the sustainability of the learning center. In an aspect, the system may maintain the learning center information documented by the learning center management committee for each of the learning centers in the system.

The method may also include providing teacher training 104. The teacher training may include a combination of training to help the teachers learn how to set up audio-visual resources in the classrooms, introduce the teachers to the video library, and help the teachers make links between the audio-visual content in the library and the syllabus content. The teacher training may tie various elements together to form a holistic curriculum that supports teachers to integrate audio-visual resources and student-centered approaches within teaching and learning while satisfying a national curriculum. For example, the teacher training may introduce teachers to student-centered learning and may take teachers through a step-by-step process of video selection, linking audio-visual content to subjects, topics, and grades that the teachers teach. Student-centered learning may include a method of instruction in which the students influence the content, activities, materials, and the pace of learning. For example, the teacher may ask open ended questions, provide guided practice to the students, provide projects for the students to work on, and provide problems for the students to solve. Benefits of student-centered learning may include, but are not limited to, strengthening student motivation, promoting peer communication, reducing disruptive behavior, building student-teacher relationships, promoting active learning, and promoting responsibility for learning.

In addition, the teacher training may provide the teachers with guides to design activities that engage students actively in the process of learning. The teacher training may also provide teachers with training on integrating audio-visual resources with lesson plans and identifying ways in which video lessons can fully integrate skills, such as, creative problem solving, collaboration, critical thinking, and communication skills. In an aspect, the teachers may receive a toolkit that supports the integration of video learning, learning skills, and student-centered methods. The toolkit may include, for example, locally developed curriculum maps and lesson plans that enable teachers to match audio-visual content to syllabi objectives and integrate the audio-visual content into lesson plans. The toolkit may also include a catalogue of useful audio-visual techniques and strategies that the teacher may use. As such, the teacher training may provide teachers with support to weave audio-visual content within core syllabus content to foster collaboration, creative problem solving, critical thinking, and the communication skills needed for students to become life-long learners and achieve academic and professional goals.

The teacher training may continue with follow up workshops that focus on, for example, gender equality, leadership, team coaching, upgrading skills, sustainability, and best practices. The workshops may promote sustainability of the learning center by teaching teachers to develop training plans for teaching new teachers on how to use audio-visual content in the classroom.

The method may further include receiving input from the community regarding topics of interest and holding community engagement workshops 106. The input from the community may be used to develop community based action plans to ensure that the learning center continues to thrive as part of the school and community. In addition, community engagement workshops may provide an opportunity for members of the community to mobilize around education and/or identify needs, challenges, and assets for the learning center. For example, a community engagement workshop may help members of the community identify needs in education for girls and women (e.g., many girls in the community are not in school) and how to address the identified needs (e.g., going door to door asking parents to send their girls to the learning center and/or providing special classrooms for girls who are older than other children in a respective grade).

In addition, the method may include providing educational input, using the technology, on a received topic of interest 108. For example, the system may generate locally developed curriculum maps and lesson plans based on the received topic of interest. The lesson plans may enable teachers to match audio-visual content to syllabi objectives and integrate the audio-visual content into lesson plans on the topic of interest.

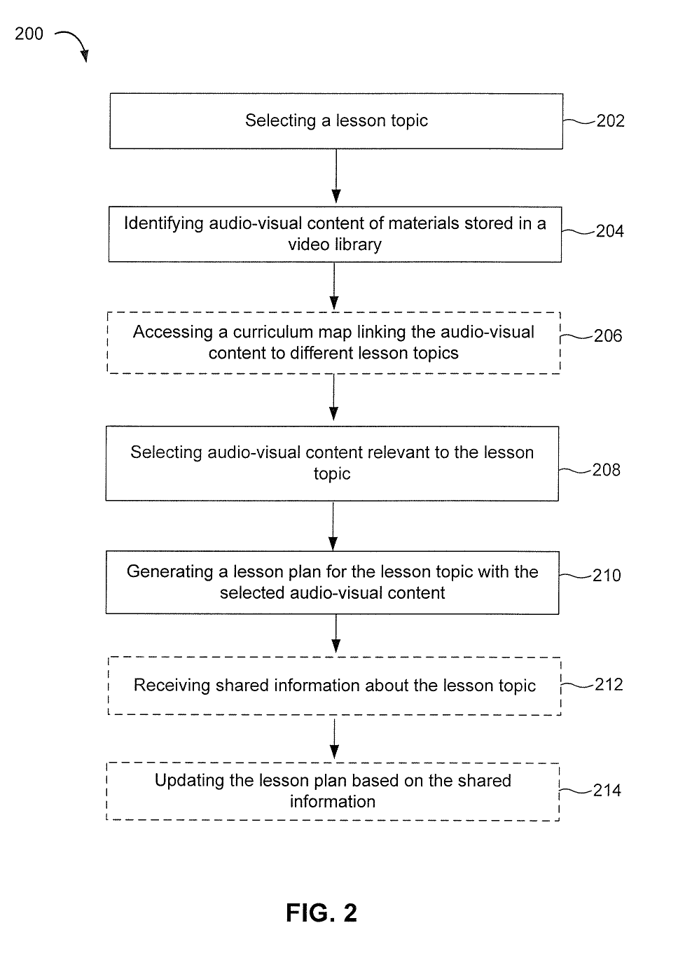

Referring now to FIG. 2, illustrated therein is an example method flow 200 for integrating audio-visual learning techniques and technology, in accordance with an aspect of the present invention. The method may include selecting a lesson topic 202. A user may select one or more lesson topics, for example, from a syllabus and/or curriculum guide. In an aspect, the system may receive a selected lesson topic from the user.

The method may also include identifying audio-visual content of materials stored in a video library 204. For example, the system may include a video library with a plurality of videos that may be used for educational purposes. The audio-visual content may be original content and/or may be curated content. The audio-visual content stored in the system may be selected in collaboration with educators from various countries. In an aspect, each video may include three or more short segments of content. The system may present of a program list of segments associated with each video stored in the video library. In addition, the system may present descriptions of the audio-visual content associated with each segment of the video. The descriptions may include, for example, an overview and running time of each video segment. The list of segments and the audio-visual content descriptions may change as the number of videos stored in the video library increases and/or decreases.

The method may optionally include accessing a curriculum map linking the audio-visual content to different lesson topics 206. For example, the system may have one or more curriculum maps stored. The curriculum maps may link audio-visual segments to different lesson topics to provide suggestions for use with different subjects (e.g., mathematics, science, language, history, arts) and grades. The same audio-visual segment may be used for a variety of subjects and/or grades.

In an aspect, the curriculum maps may correspond to a national syllabus for a given country. The curriculum maps may provide direct connections between video content and the syllabus objectives and topics for the country. The national ministries may be engaged in examining how the audio-visual library complements the national level curriculum. For example, the curriculum maps may be designed to incorporate country specific educational requirements. The curriculum maps may be updated as educational requirements for a specific country change.

The method may also include selecting audio-visual content relevant to the lesson topic 208. For example, a user may select the audio-visual content relevant to the lesson topic. The system may present a list of audio-visual content and a description of the audio-visual content. The user may use the descriptions of the audio-visual content to select video content that may be relevant to the lesson topic. In an aspect, the user may access the curriculum map for suggestions on which audio-visual content to use for different lesson topics and grades. In another aspect, the system may automatically select audio-visual content relevant to the lesson topic based on a stored mapping and/or linking of the audio-visual content to lesson topics. For example, a curriculum map stored in the system may link audio-visual content to the lesson topics. The system may access the curriculum map, select the audio-visual content mapped to the lesson topic on the curriculum map, and present the selected audio-visual content.

In addition, the method may include generating a lesson plan for the lesson topic with the selected audio-visual content 210. The lesson plan may include, for example, a date for the lesson, the lesson topic, and the lesson plan objectives. The lesson plan objectives may describe what the students should be able to achieve by the end of the lesson. In addition, the lesson plan may identify the various materials needed for the lesson, including the selected video content to use in the lesson plan.

The lesson plan may also identify various activities that incorporate the audio-visual content and emphasize core learning skills to teach the lesson topic. Core learning skills may include, for example, communication, collaboration, critical thinking, and creativity. Activities may be fun and engaging so students may learn a lesson topic in a creative way. Example activities may include, but are not limited to, students developing a story together as a group about the audio-visual content, students creating a collage of information described in the audio-visual material, identifying items viewed in the audio-visual material, identifying key words mentioned in the audio-visual material, and creating a chart of information from the audio-visual material. In addition, the lesson plan may integrate gender neutral aspects and/or terminology into the lesson plan.

The lesson plan may also include core points to teach to the students and an evaluation on whether the students learned the core points. In an aspect, the system may generate the lesson plan based on received user input from teachers. For example, the teachers may input the lesson topic, the lesson plan objectives, the lesson plan activities, a date for the lesson, materials needed for the lesson plan, audio-visual content to use in the lesson plan, core points of the lesson, and an evaluation of the lesson. The information included in a lesson plan may differ based on country requirements, school requirements, and/or teacher preferences.

The method may optionally include receiving shared information about the lesson topic 212. For example, various teachers from different schools and/or countries may share practices that have worked in the classroom, provide teaching tips, share feedback on approaches that did not work, share feedback on lessons that students enjoyed, technology challenges, and any other information that the teachers want to share about the lesson plans. Forums may be created for the teachers to share the information. In an aspect, the system may collect the shared information by the teachers and the store the shared information.

The method may also optionally include updating the lesson plan based on the shared information 214. For example, teachers may access the shared information stored by the system and update one or more lesson plans based upon the shared information. In addition, one or more curriculum guides may be updated based upon the shared information. As such, the lesson plans and curriculum guides may be updated based on the collective knowledge shared by other educators using the system.

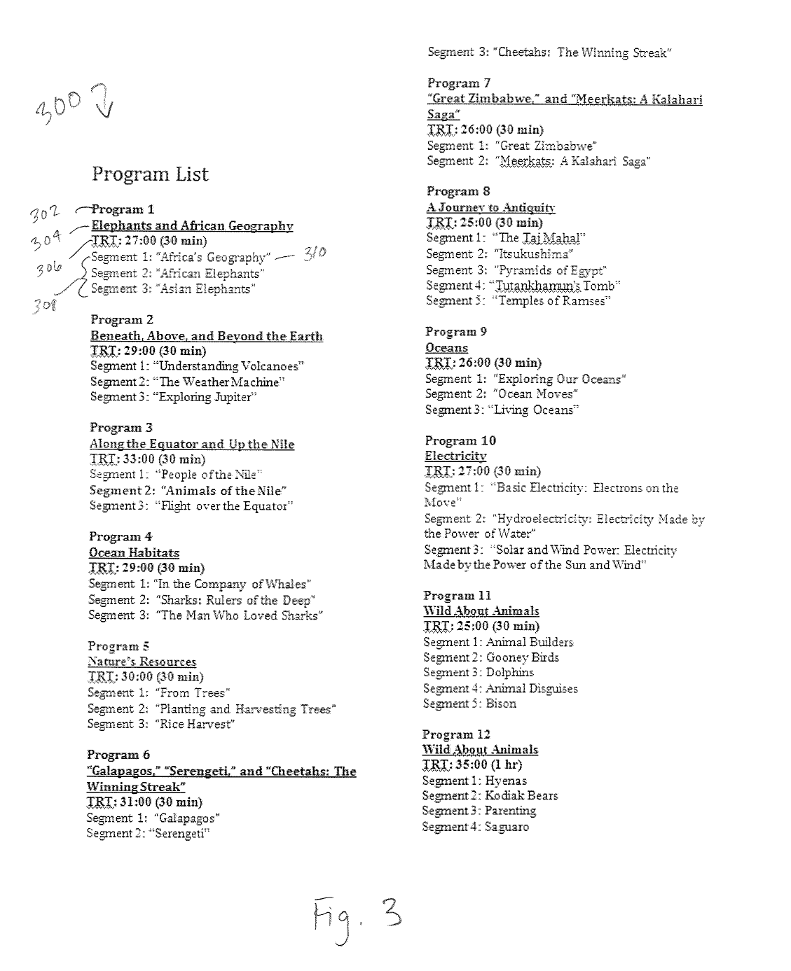

Referring now to FIG. 3, illustrated therein is an example audio-visual content list, e.g., video program list 300 in accordance with an aspect. In an aspect, the system may present video program list 300 with video program information for each of the videos stored in a video library on the system. Video program information may include, but is not limited to, a video program number 302, a video program name 304, a total running time of the video program 306, a number of segments in the video program 308, and segment descriptions 310. The video program names 304 and segments descriptions 310 may be used in selecting audio-visual content that may relate to lesson topics.

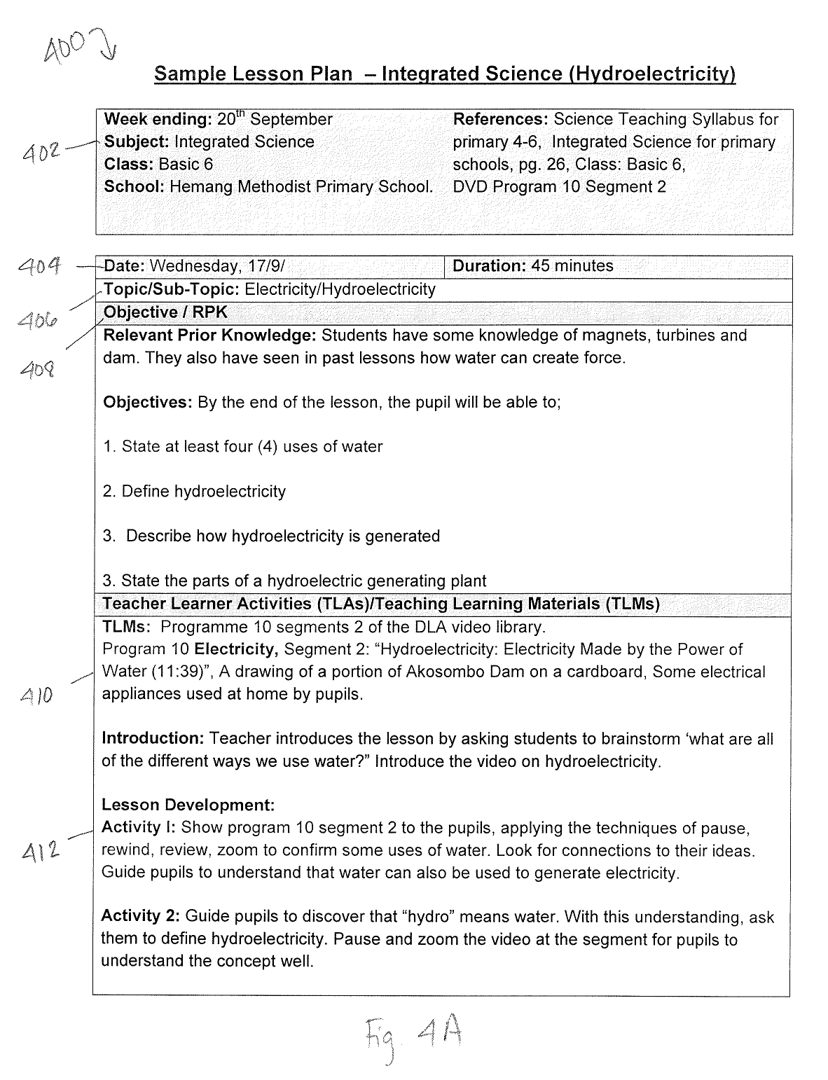

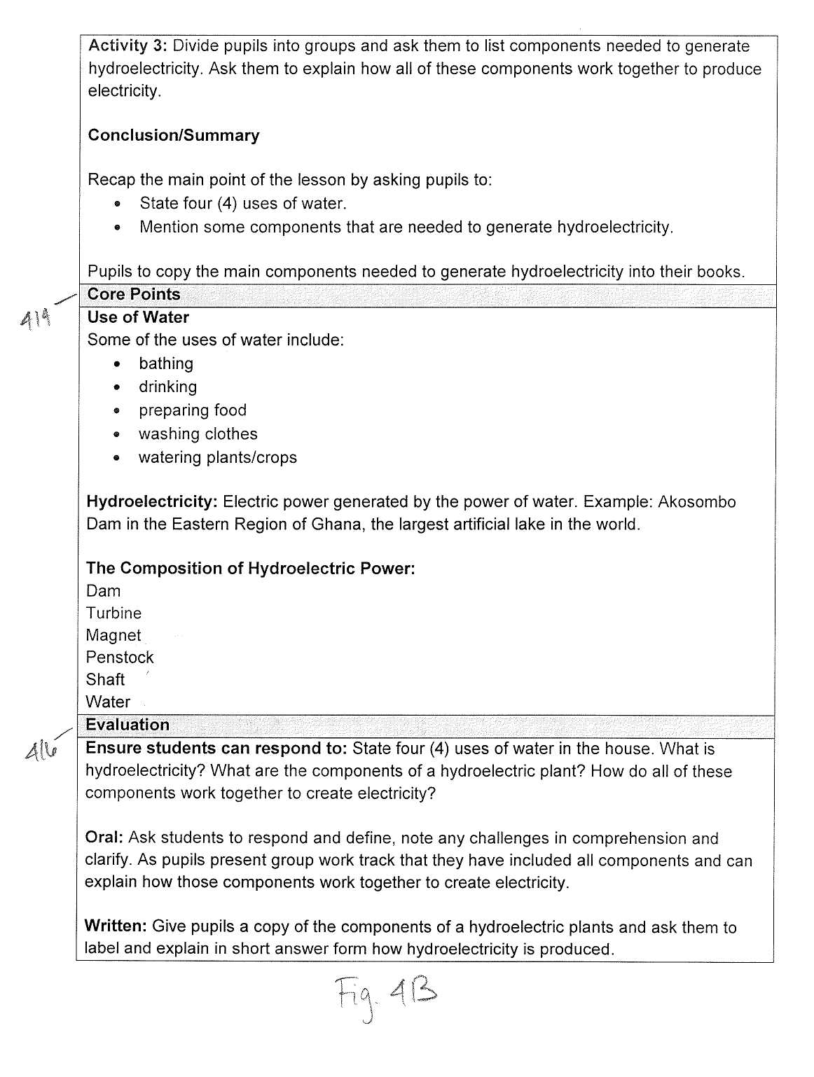

FIGS. 4A and 4B illustrate an example lesson 400 plan in accordance with an aspect. For example, the system may be used to generate lesson plan 400. Lesson plan 400 may include, for example, a subject 402, a date of the lesson 404, a lesson topic 406, lesson objectives 408, video program and segment information 410 needed for the lesson, lesson activities 412, core points for the lesson 414, and a lesson evaluation 416. Lesson plan 400 may have different formats based on country requirements, school requirements, and/or teacher preferences.

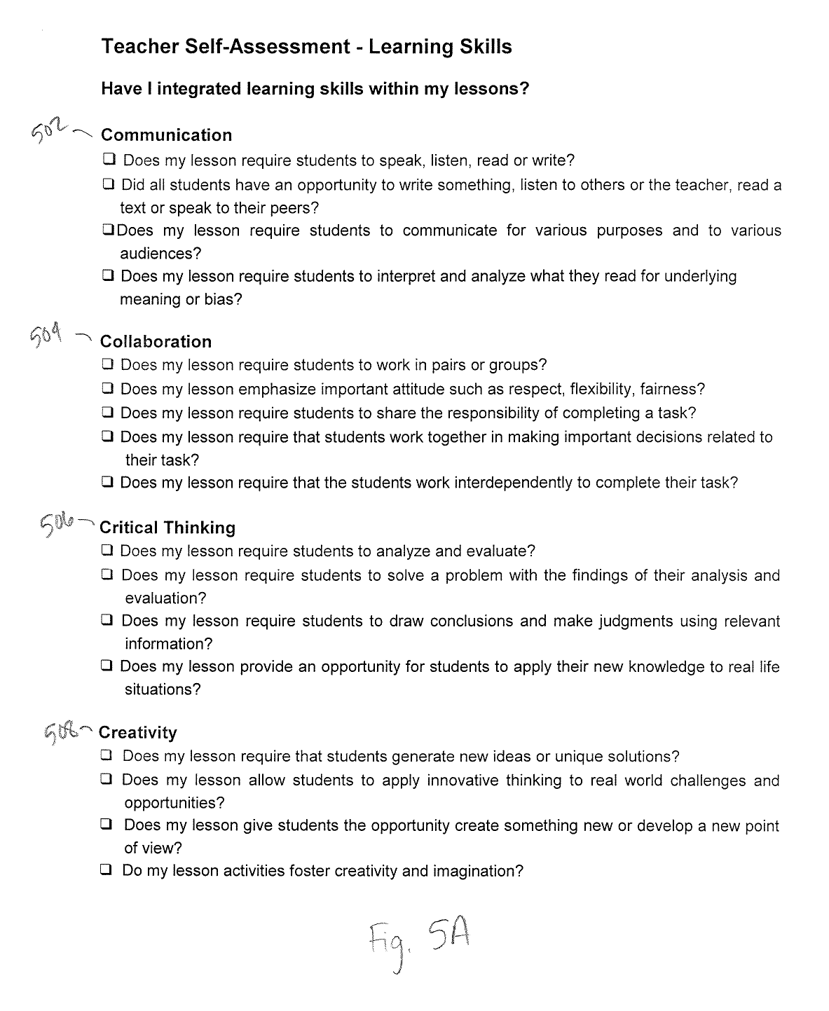

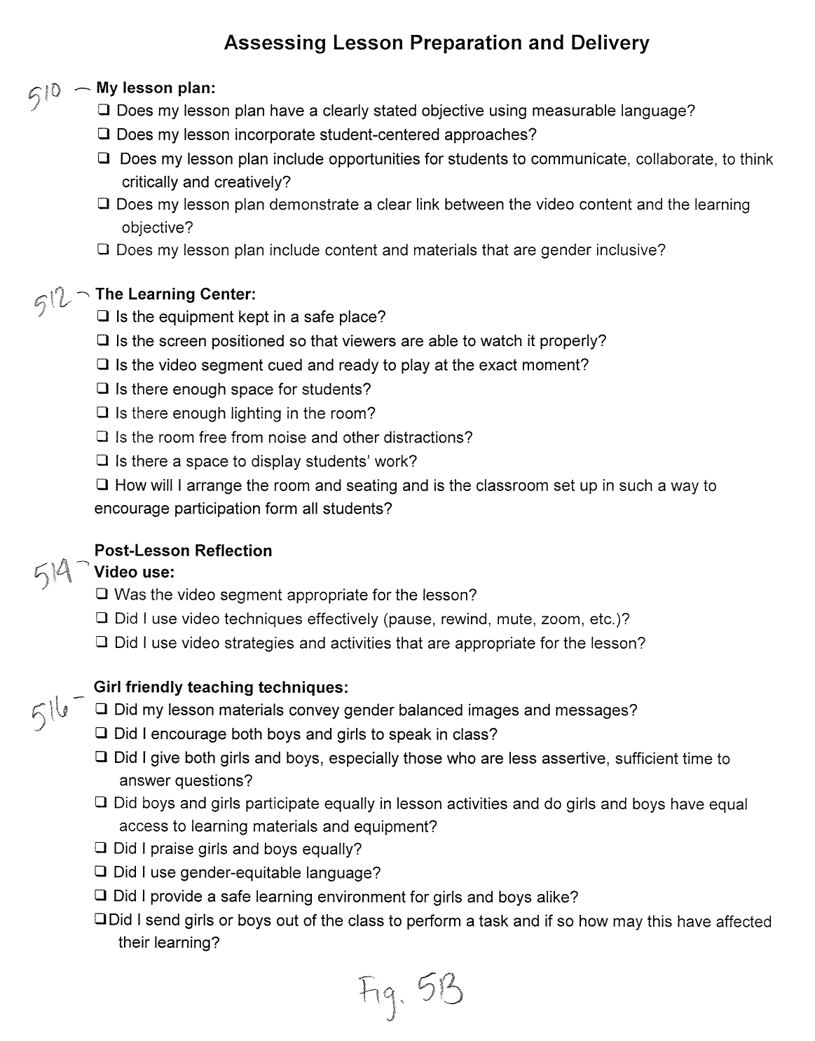

Referring now to FIGS. 5A and 5B, illustrated therein is an example assessment 500 in accordance with an aspect of the present invention. In an aspect, the system may generate the assessment 500. The assessment 500 may be used by the teacher to evaluate a lesson plan and whether learning skills have been integrated within the lesson. The teacher may be able to use the assessment 500 to evaluate a lesson plan and make improvements for future lesson plans. For example, the assessment 500 may include questions about communication 502, collaboration 504, critical thinking 506, and creativity 508.

The assessment 500 may also be used by the teacher to evaluate the preparation and delivery of the lesson plan. For example, the assessment 500 may include questions about the lesson plan 510, the learning center 512, post-lesson video reflection video use 514, and girl friendly teaching techniques 516. The teacher may use the questions on the assessment 500 to evaluate the delivery of the lesson plan and make improvements for future lesson plans.

One variation of the aspects of the present invention may include integrating mass media (e.g., including radio, television, newspapers, magazines, Internet, social media, such as Twitter or Facebook, and mobile mass communication, among other forms of mass media) with messaging about education. For example, messaging may be included in mass media about the value of education and the value of education for girls and women. In addition, the learning centers may be used to facilitate community activities related to the mass media programming, such as viewing clubs or forums to facilitate conversations about issues raised during the mass media programming.

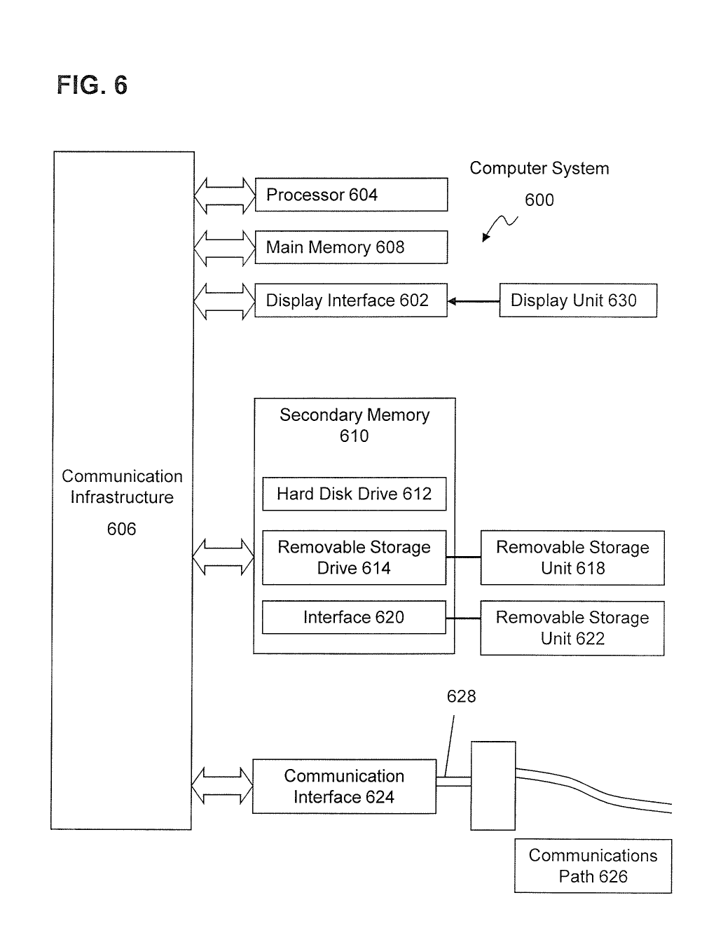

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 600 is shown in FIG. 6.

Computer system 600 includes one or more processors, such as processor 604. The processor 604 is connected to a communication infrastructure 606 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 600 can include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, a universal serial bus (USB) flash drive, etc. The removable storage drive 614 reads from and/or writes to a removable storage unit 618 in a well-known manner. Removable storage unit 618 represents a floppy disk, magnetic tape, optical disk, USB flash drive etc., which is read by and written to removable storage drive 614. As will be appreciated, the removable storage unit 618 includes a computer usable storage medium having stored therein computer software and/or data.

Alternative aspects of the present invention may include secondary memory 610 and may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 680, a hard disk installed in hard disk drive 670, and signals 628. These computer program products provide software to the computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features in accordance with aspects of the present invention, as discussed herein. In particular, the computer programs, when executed, enable the processor 604 to perform the features in accordance with aspects of the present invention. Accordingly, such computer programs represent controllers of the computer system 600.

In an aspect of the present invention where the invention is implemented using software, the software may be stored in a computer program product and loaded into computer system 600 using removable storage drive 614, hard drive 612, or communications interface 620. The control logic (software), when executed by the processor 604, causes the processor 604 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, the invention is implemented using a combination of both hardware and software.

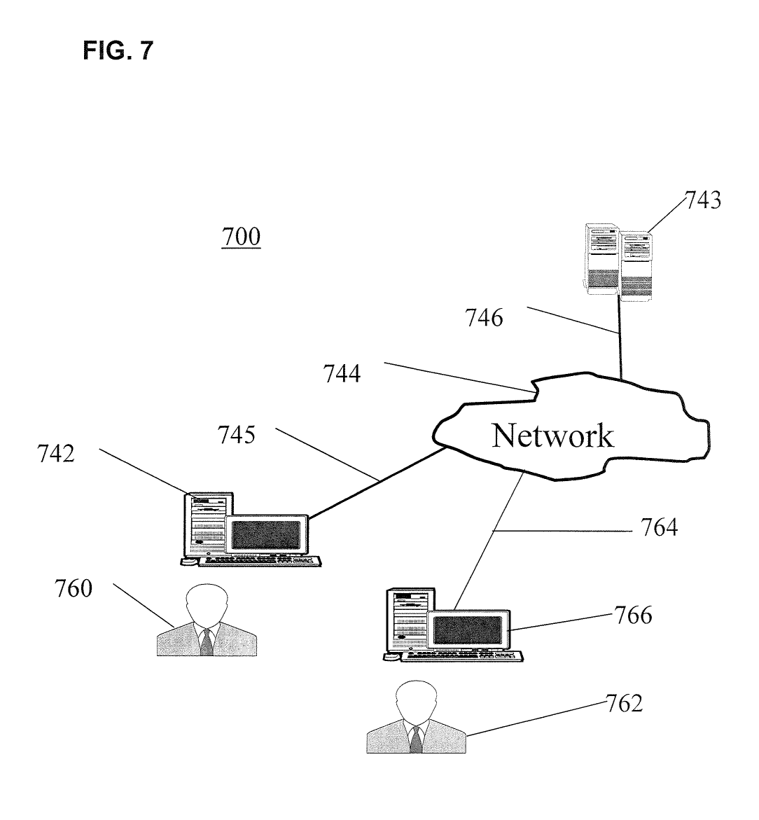

FIG. 7 shows a communication system 700 usable in accordance with aspects of the present invention. The communication system 700 includes one or more accessors 760, 762 (also referred to interchangeably herein as one or more “users”) and one or more terminals 742, 766. In one aspect of the present invention, data for use is, for example, input and/or accessed by accessors 760, 764 via terminals 742, 766, such as personal computers (PCs), minicomputers, mainframe computers, microcomputers, telephonic devices, or wireless devices, such as personal digital assistants (“PDAs”) or a hand-held wireless devices coupled to a server 743, such as a PC, minicomputer, mainframe computer, microcomputer, or other device having a processor and a repository for data and/or connection to a repository for data, via, for example, a network 744, such as the Internet or an intranet, and couplings 745, 746, 764. The couplings 745, 746, 764 include, for example, wired, wireless, or fiberoptic links. In another aspect of the present invention, the method and system of the present invention operate in a stand-alone environment, such as on a single terminal.

While aspects of the present invention have been described in connection with examples thereof, it will be understood by those skilled in the art that variations and modifications of the aspects of the present invention described above may be made without departing from the scope hereof. Other aspects will be apparent to those skilled in the art from a consideration of the specification or from a practice in accordance with aspects of the invention disclosed herein.

1. An equipment-based educational method comprising:
developing a learning center integrating audio-visual learning techniques and technology;
providing teacher training;
receiving input from the community regarding topics of interest; and
providing educational input, using the technology, on a received topic of interest.

2. The method of claim 1, wherein integrating audio-visual learning techniques and technology further comprises:
identifying audio-visual content of materials stored in a video library; and
selecting audio-visual content relevant to a lesson topic.

3. The method of claim 2, wherein the audio-visual content include a plurality of segments with educational content.

4. The method of claim 2, further comprising:
accessing a curriculum map linking the audio-visual content to the lesson topic; and
using the curriculum map to select the audio-visual content relevant to the lesson topic.

5. The method of claim 4, wherein the curriculum map corresponds to a national syllabus for a country.

6. The method of claim 2, further comprising:
generating a lesson plan for the lesson topic with the selected audio-visual content.

7. The method of claim 6, further comprising:
receiving shared information about the lesson topic; and
updating the lesson plan based on the shared information.

8. An apparatus comprising:
a component for use in developing a learning center integrating audio-visual learning techniques and technology;
a component for providing teacher training;
a component for receiving input from the community regarding topics of interest; and
a component for providing educational input, using the technology, on a received topic of interest.

9. The apparatus of claim 8, wherein integrating audio-visual learning techniques and technology further comprises:
a component for identifying audio-visual content of materials stored in a video library; and
a component for selecting audio-visual content relevant to a lesson topic.

10. The apparatus of claim 9, wherein the audio-visual content include a plurality of segments with educational content.

11. The apparatus of claim 9, further comprising:
a component for accessing a curriculum map linking the audio-visual content to the lesson topic; and
a component for using the curriculum map to select the audio-visual content relevant to the lesson topic.

12. The apparatus of claim 11, wherein the curriculum map corresponds to a national syllabus for a country.

13. The apparatus of claim 9, further comprising:
a component for generating a lesson plan for the lesson topic with the selected audio-visual content.

14. The apparatus of claim 13, further comprising:
a component for receiving shared information about the lesson topic; and
a component for updating the lesson plan based on the shared information.

15. A computer program product, comprising:
a computer-readable medium comprising:
at least one instruction for causing a computer to develop a learning center integrating audio-visual learning techniques and technology;
at least one instruction for causing the computer to provide teacher training;
at least one instruction for causing the computer to receive input from the community regarding topics of interest; and
at least one instruction for causing the computer to provide educational input, using the technology, on a received topic of interest.
